(19) United States
(12) Patent Application Publication
(10) Pub. No.: US 2010/0014615 A1
(43) Pub. Date: Jan. 21, 2010

(54) Systems and methods for demodulating multiply-modulated communications signals

(76) Inventors: Gregory H. Piesinger, Cave Creek, AZ (US); James R. Troxel, Glendale, AZ (US); Gregory T. Stayton, Peoria, AZ (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 12/455,886

(22) Filed: Jun. 8, 2009

Related U.S. Application Data
(60) Provisional application No. 61/059,736, filed on Jun. 6, 2008.

(51) Int. Cl. H04L 27/06

(52) U.S. Cl. 375/340

(57) ABSTRACT

Embodiments of the present invention provide for an overall hardware and software approach to Mode-S demodulation, especially where the Mode-S signals (such as squitters) have been modulated with multiple modulation protocols. Various implementations utilize coherent phase detection, since coherently detecting phase transitions in a multiple modulated signal results in better sensitivity and improved interference rejection over non-coherent modulation techniques. Further, addressing the demodulation of multiply-modulated signals may also be approached in embodiments of the present invention as a unified demodulation system, rather than disjoint demodulation of the separately modulated protocols.

### CROSS-REFERENCE TO RELATED APPLICATION

This application claims priority to U.S. Provisional Patent Application Ser. No. 61/059,736, filed Jun. 6, 2008, the disclosure of which is incorporated by reference in its entirety.

### DESCRIPTION OF THE INVENTION

1. Field of the Invention

The present invention relates to systems and methods for encoding/modulating and decoding/demodulating digital information, and more particularly, to systems and methods for demodulating multiply-modulated communication signals, especially air-traffic-control-related electronic signals.

2. Background of the Invention

Travel by aircraft is generally a safe and efficient way for travelers to reach remote destinations. Over the years, as the popularity of air travel has dramatically increased, the need for techniques for safely managing the flow of aircraft has also risen. To address air traffic safety issues, aircraft have been equipped with avionics equipment such as transponders that assist air traffic controllers in identifying, tracking, and managing aircraft in flight.

Through radio frequency transmissions, transponders provide air traffic controllers and other suitably equipped aircraft with information such as aircraft identification, altitude, and other aircraft-specific data. Ready access to such information allows controllers and pilots to utilize airspace in a safer and more efficient manner. As the density of air traffic grows, it is understandable that there is a growing need for more information to be relayed between aircraft and ground stations on a near-real-time basis.

Currently, FAA Air Traffic Control and most other ATC controlling authorities around the world use standard modulation schemes to ensure interoperability of their radio frequency signals with other aircraft and systems. For example, the Minimum Operational Performance Standards for Air Traffic Control Radar Beacon System/Mode Select (ATCRBS/Mode S) Airborne equipment, promulgated by RCTA as RTCA/DO-181 C (and incorporated by reference herein in its entirety) defines pulse position modulation on 1090 MHz for Mode S transponder and older transponder (ATCRBS transponders) replies to 1030 MHz ground station and WAS interrogations. By using standard protocols aircraft state information as well as other data can be relayed aircraft to ground, ground to aircraft, or in some instances aircraft to aircraft.

Automatic Dependent Surveillance Broadcast (ADS-B) represents one example of expansion of capability within spectrum and format restrictions of an existing standard. ADS-B messages such as Mode-S squitters may be identified by their header format, and while they utilize the same frequencies as legacy systems such as ATCRBS, they are designed not to interfere with existing equipment. Thus, ADS-B protocols allow for augmented communications capabilities, provided the waveforms utilized are constrained to acceptable formats and performance characteristics. Incompatible legacy equipment may receive such enhanced signals, even if the information is extraneous to their operation, and the rejection of unrecognized symbols does not necessarily impede performance of legacy equipment.

The volume of information that must be transmitted from aircraft continues to increase as more advanced avionics and traffic control systems become available. Likewise, the need to transmit diverse information of all kinds also drives the

desire to utilize aircraft systems to send data. However, because of the large number of required transponder replies in heavily traveled areas (such as in the vicinity of an airport, where hundreds of replies per second are generated), there are worldwide limits on the number of transponder broadcast transmissions permitted each second from each aircraft. For example, the limit for ADS-B is currently set to 6.2 transmissions per second to prevent the additional ADS-B interference from potentially all the aircraft near a major airport creating a situation where the ATC ground station becomes unable to receive surveillance replies from aircraft in the terminal area being controlled by ATC.

ADS-B squitter data content has already been defined for the most part by industry committees such as SC 186, and there is little remaining room for future growth. In fact, systems currently envisioned and being developed by avionics systems designers will likely need to transmit more data than can be sent within the 6.2 squitters per second limit. The ability to employ more data in avionic systems is now and will continue to be needed. However, expansion into new spectrum or revision of existing standards may render obsolete billions of dollars of infrastructure and avionics equipment. What is needed are methods and systems to increase data throughput and provide for additional communication links without significant impact on existing ATC systems and spectrum. What is also needed are methods and systems to efficiently demodulate communication signals that have been modulated with multiple modulation protocols. What is also needed are systems and methods to demodulate multiply-modulated signals in a noise-prone environment. What is further needed are systems and methods to improve error performance of RF communications in a noise-prone environment.

### SUMMARY OF THE INVENTION

Embodiments of the present invention provide for an overall hardware and software approach to Mode-S demodulation, especially where the Mode-S signals (such as squitters) have been modulated with multiple modulation protocols. Various implementations utilize coherent phase detection, since coherently detecting phase transitions in a multiple modulated signal results in better sensitivity and improved interference rejection over non-coherent modulation techniques. Further, addressing the demodulation of multiply-modulated signals may also be approached in embodiments of the present invention as a unified demodulation system, rather than disjoint demodulation of the separately modulated protocols.

Various embodiments of the systems and methods of the present invention include a Binary Detector Block Data Preprocessor; a Preamble, Frequency, and Initial Phase Detector; a Coherent Matched Filter Detector with Coherent Demodulation; an Erasure Perturbation Generator, a Null Steering approach including TCAS-based Null steering approaches and Mode-S-related null steering approaches; and GPS-stabilized Mode-S timing.

Both the foregoing summary and the following detailed description are exemplary and explanatory only and are not restrictive of the invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

A more complete understanding of the present invention may be derived by referring to the detailed description and claims when considered in connection with the following illustrative figures.

FIG. 1 depicts an exemplary Mode S demodulation system (and elements of its operation) according to various aspects of the present invention.

FIG. 2 depicts an exemplary binary detector block data preprocessor system (and elements of its operation) according to various aspects of the present invention.

FIG. 3 illustrates a typical low level Mode S squitter overlaid with high level ATCRBS interference.

FIG. 4 illustrates the block data after isolating the squitter and editing the interference.

FIG. 5 depicts an exemplary preamble, frequency, and initial phase detector (and elements of its operation) according to various aspects of the present invention.

FIG. 6 illustrates a typical cross correlation over the duration of the squitter.

FIG. 7 illustrates a smaller search area of the correlation depicted in FIG. 6.

FIG. 8 depicts an exemplary coherent matched filter detector (and elements of its operation) according to various aspects of the present invention.

FIGS. 9 and 10 illustrate exemplary Reed Solomon (RS) codes according to various aspects of the present invention.

FIG. 11 illustrates an exemplary method for using overlay bits to provide additional forward error correction (FEC) to Mode S messages.

FIG. 12 depicts an exemplary GPS stabilized frequency system (and elements of its operation) according to various aspects of the present invention.

FIGS. 13-21A pertain to various exemplary bits described in detail under “Coherent Demodulation” below.

### DETAILED DESCRIPTION OF EXEMPLARY EMBODIMENTS

In one embodiment of the present invention, a communication system involving multiply-overlayed ATC signals is viewed as communication link in which both the Mode S message and phase overlay are implemented using an optimum coherent matched filter demodulator with Reed Solomon (RS) Forward error correction (FEC) coding. In the following sections, various embodiments disclosures are described for modules that may be used to implement the present invention.

### Mode S Demodulation Process

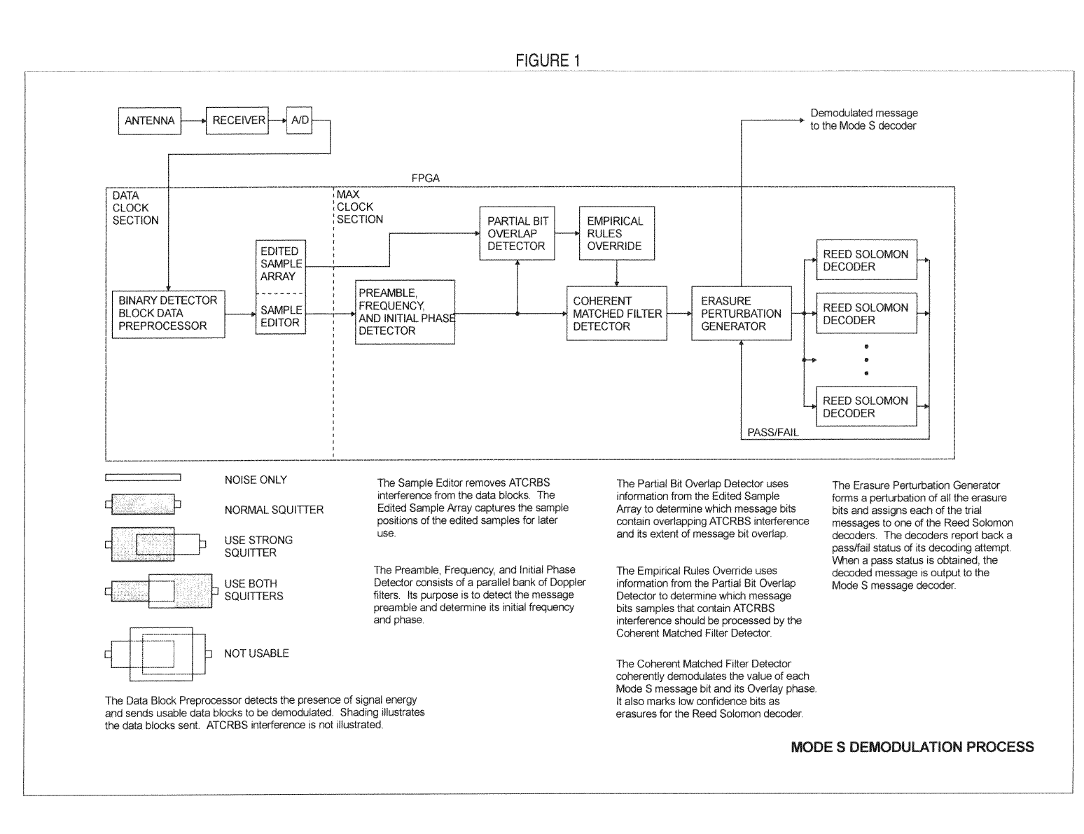

A block diagram for the overall Mode S and ATC Overlay coherent matched filter demodulator is illustrated in FIG. 1. Those of skill in the relevant arts appreciate that any number of approaches could be utilized to implement the illustrated diagrams, including hardware such as field programmable gate arrays (FPGAs) or other desirable approaches.

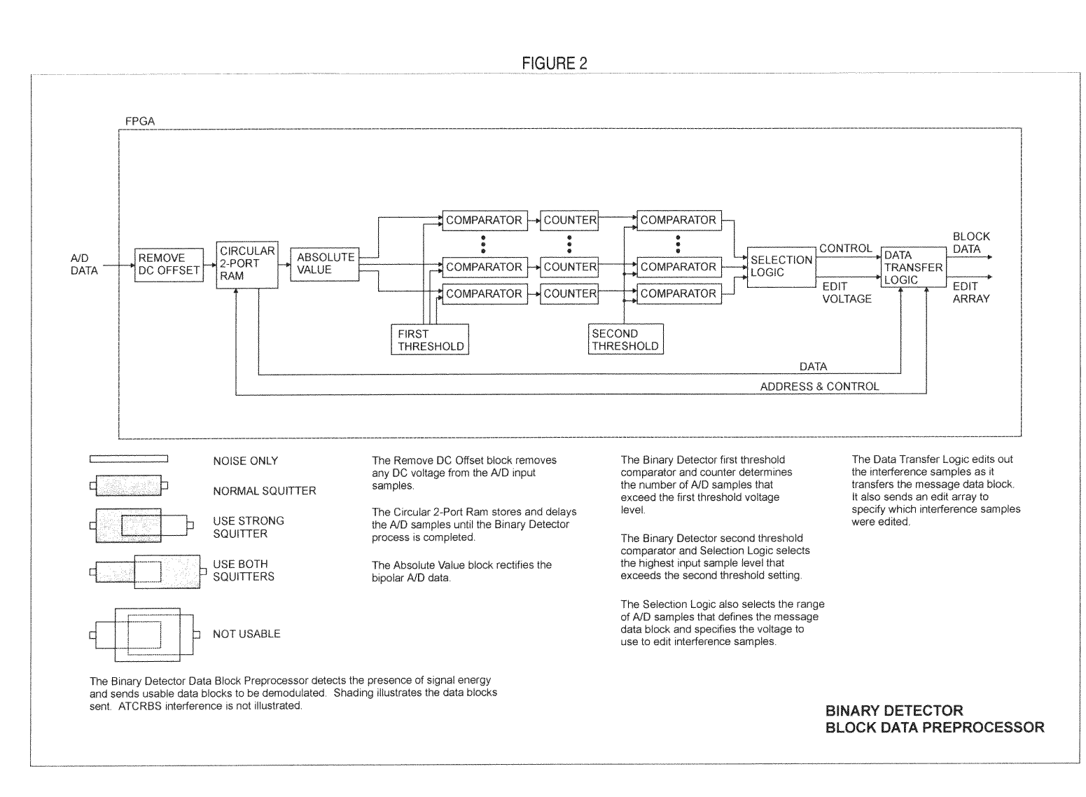

The present invention provides a system that can work with squitters at all power levels, overlap, and ATCRBS interference. One embodiment of this approach is provided by the Binary Detector Block Data Preprocessor and Sample Editor illustrated in FIG. 2. Among other things, the illustrated modules break incoming signals into usable squitter data blocks and edit out any ATCRBS interference. Those portions of squitters that have a possibility of being decoded are sent to the subsequent modules.

For example, a normal stand-alone squitter will be detected by its power level above the noise and all the squitter A/D samples will be selected for demodulation. The same is true for a strong squitter later overlapped by a low power squitter. However, the trailing end of the low power squitter will not be transferred because not enough of that squitter is available to be successfully decoded.

If Overlay phase is used for squitter error correction, then the non-overlapping portion of two overlapping squitters will both be isolated and transferred as long as the overlap is less than about 50 percent. If squitter overlap is such that neither of the two squitters have any chance of being decoded, they will not be transferred.

Blocks of squitter A/D samples that make it through the preprocessor are sent to the Preamble, Frequency, and Initial Phase Detector. The purpose of this module is to detect the Mode S frequency offset, preamble, and initial phase.

The preamble detector indicates the initial Mode S message sample. The frequency offset and initial phase defines the frequency and initial phase of the FPGA LO coherent downconverter.

The Coherent Matched Filter Detector optimally demodulates the value of each Mode S message bit and phase overlay by cross correlating the squitter with each of the MPSK LO signals. Each decoded message bit and phase value are determined by the LO cross correlation that yields the highest value.

When ATCRBS interference is present, empirical rules override the coherent matched filter detector in some cases. For example, if all the samples in a “1” bit position are edited out due to ATCRBS interference, then the noise in the “0” bit position will be greater and the detector will erroneously decode the message bit as a “0”. The override rules prevent this based on the signal level and portion of the bit position corrupted by the interference.

This overlap portion is determined from the Edited Sample Array, which indicates which samples were edited, and their position with respect to a message bit. The empirical rules also indicates the position and confidence of overridden bits. This information is used to form multiple messages from a perturbation of these low confidence bits. The Erasure Perturbation Generator sends multiple messages to a bank of RS decoder. Only the correct message will be successfully decoded.

By using the preprocessor, all the subsequent modules can be operated at maximum clock speed in the FPGA. This maximizes the processing capability of the FPGA and allows some functions to be processed serially instead of in parallel. It also allows the maximum number of RS decoder processes to be implemented.

### Binary Detector Block Data Preprocessor

A block diagram of the Binary Detector Block Data Preprocessor is illustrated in FIG. 2. The preprocessor uses an element that is also used in weather radars, which have a similar type of interference problem. In weather radar, strong alien radar signals must be removed from normal low level radar returns without altering the signal level of those returns. Removing these high level interference pulses is very difficult using filters.

A binary detector is an element that applies two different thresholds to an incoming signal. The first threshold divides the signal into a series of amplitude bins (signal levels). The second threshold counts the number of times a signal is either equal to or greater than each signal level. Only signals that meet the criteria of the two thresholds are detected.

In effect, the binary detector is an element in which a strong interfering pulse only has one vote. This is in stark contrast to a filter which integrates the energy of the strong pulse. That is, a couple of strong interference pulses overlaying a weak desired signal will dramatically increase the output of a filter. However, in a binary detector it only adds a couple of counts to the first threshold detector which is eliminated by the second threshold detector.

As illustrated in FIG. 2, any DC voltage is first removed from the incoming signal samples and the samples are placed in a circular RAM. These samples are rectified (absolute value) and passed through the binary detector. The selection logic only detects those signals (squitters) whose signal level is constant over the minimum duration required to ensure successful decoding.

For example, since there are 120 microsecond times 64 samples per microsecond in a squitter, a squitter must exceed a particular dBm signal level for a predetermined number of counts to be judged free of other squitter overlap.

The theory of binary detectors and the selection of the first and second threshold values is well developed. For one exemplary embodiment, amplitude bins could be used with a separation on the order of 1 or 2 dB for input signal levels from −87 dBm to around −20 dBm.

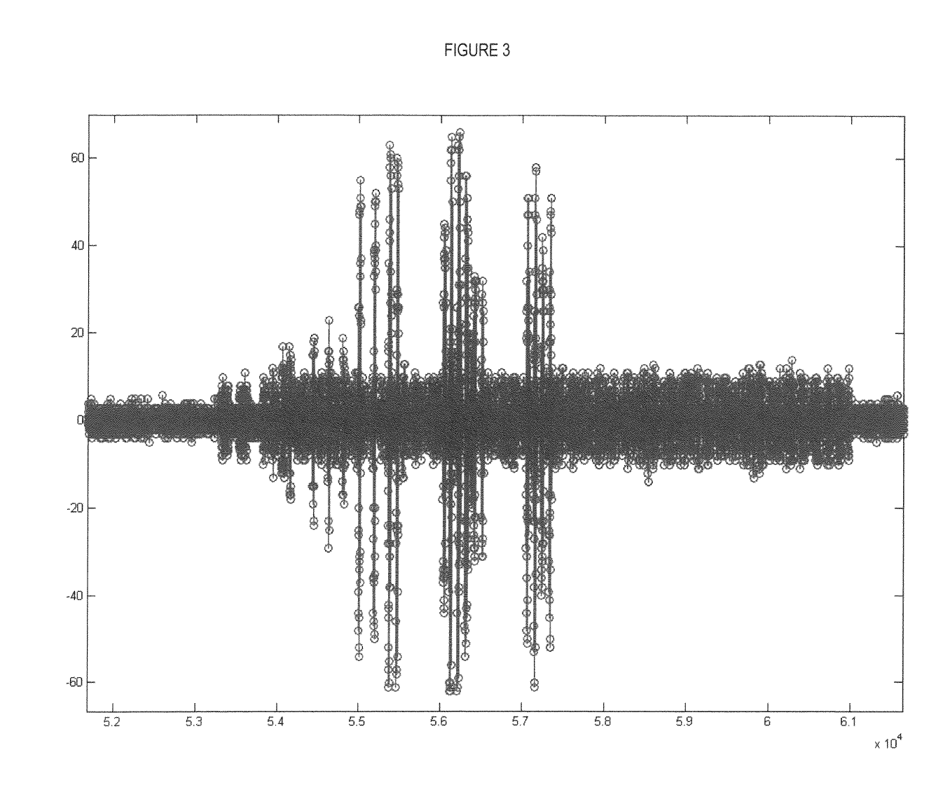

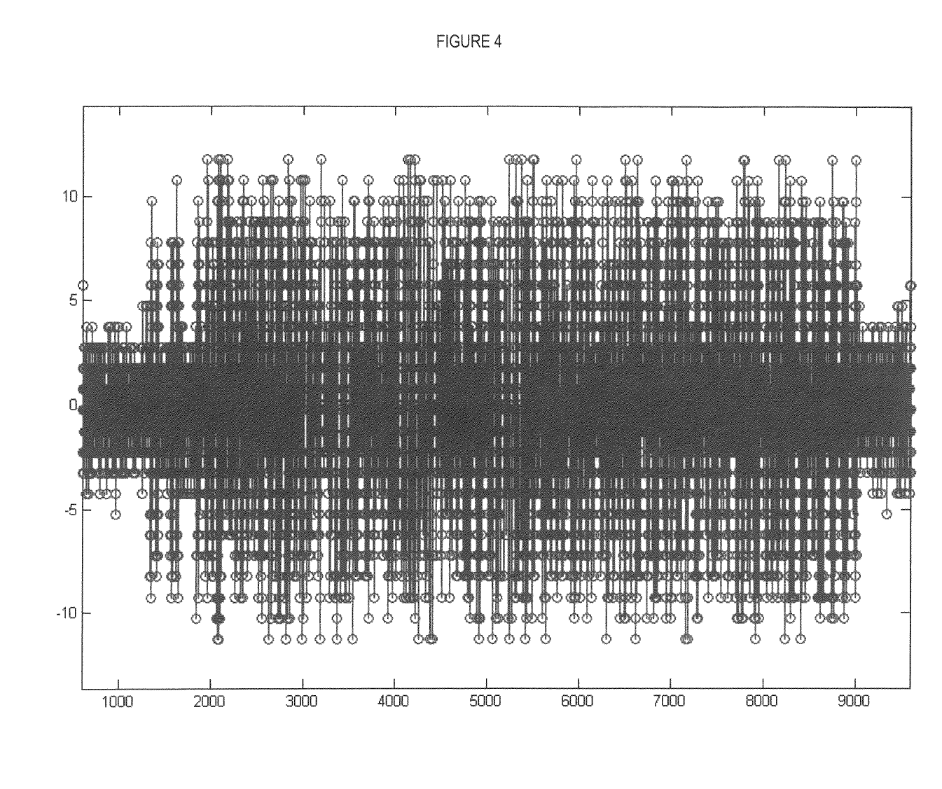

Squitters that make it through the preprocessor will be edited of ATCRBS interference and sent to the downstream modules. FIG. 3 illustrates a typical low level Mode S squitter overlaid with high level ATCRBS interference. FIG. 4 illustrates the block data after isolating the squitter and editing the interference.

### Preamble, Frequency, and Initial Phase Detector

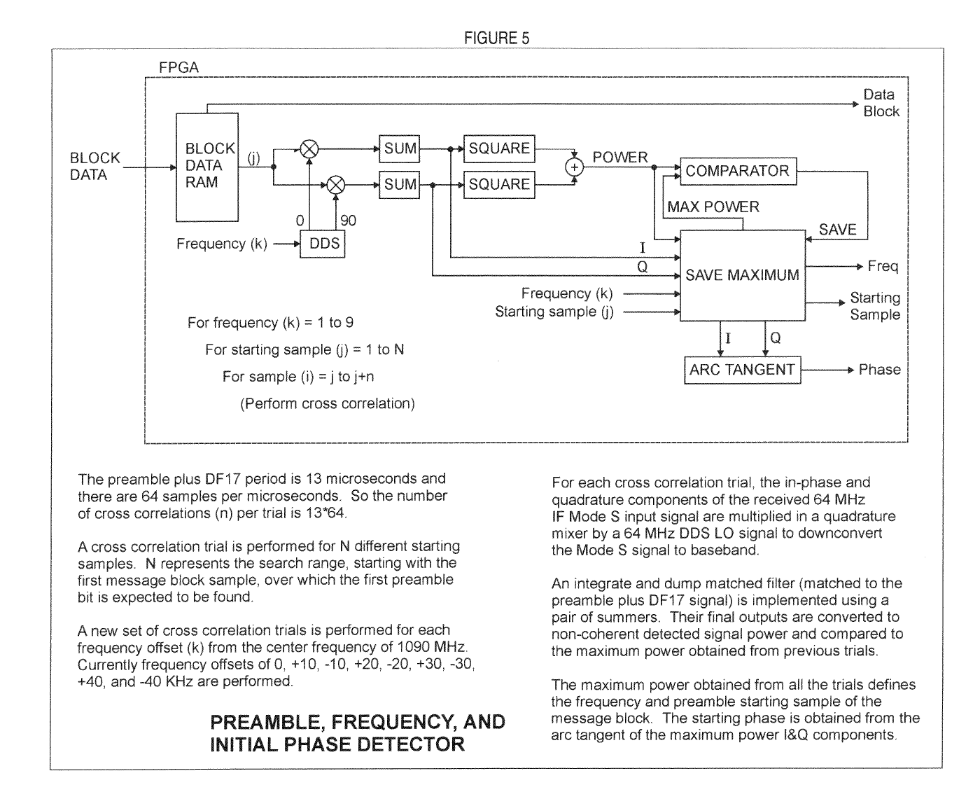

A block diagram of the Preamble, Frequency, and Initial Phase Detector is illustrated in FIG. 5. Squitter data from the preprocessor is cross correlated with an I&Q LO signal from the FPGA DDS which downconverts the squitter signal to baseband. The SUM blocks are matched to the preamble plus DF17 signal and form a matched filter. The output signals are squared to determine the cross correlation power.

A new cross correlation trial is made for each frequency and starting sample search. Whenever a new higher power is obtained, it is saved along with the frequency, starting sample and I&Q components. The maximum trial power (peak cross correlation) defines the squitter starting sample, its frequency offset, and its starting phase. The starting phase is determined from the arc tangent of the I&Q components.

There are multiple ways to implement this function in the FPGA. A single DDS can be used to serially run all the trials or multiple DDS implementations can be used to search different frequency offsets simultaneously. Alternatively, a ROM lookup table can be used to define the LO signal samples for each frequency offset.

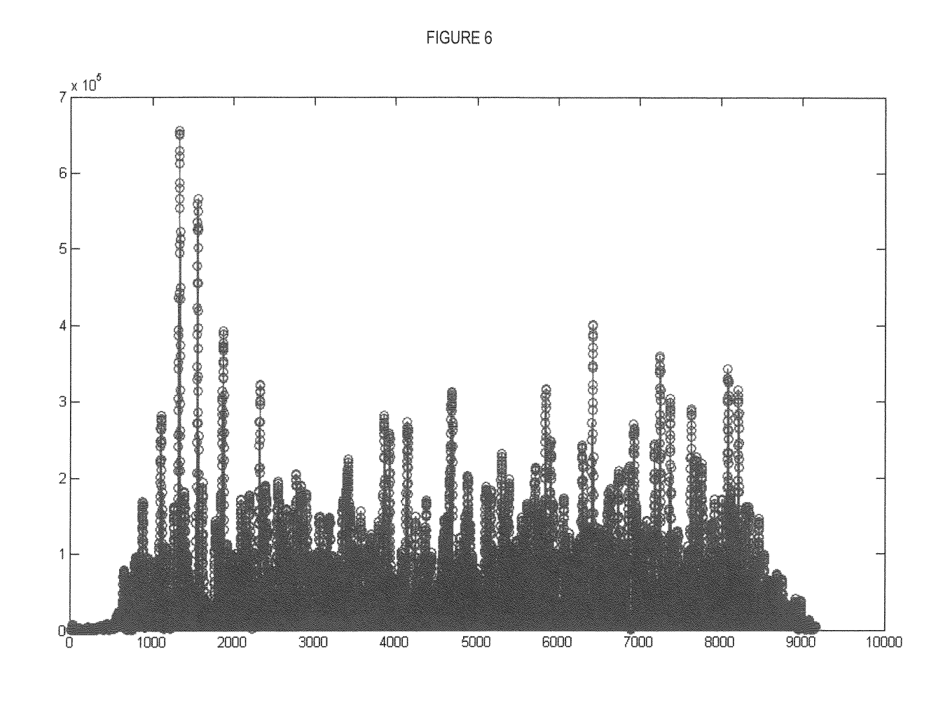

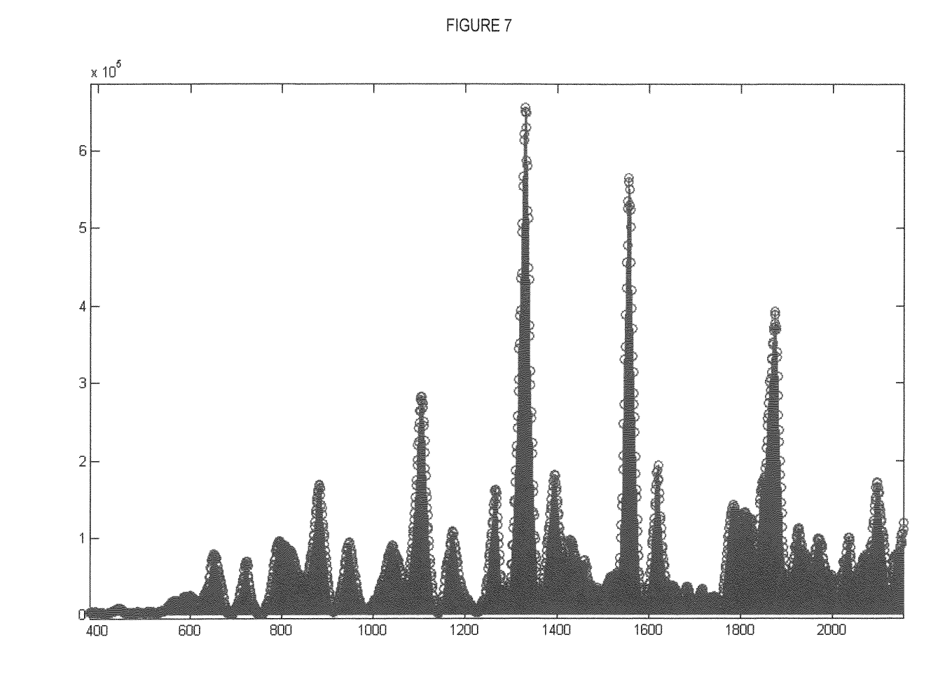

FIG. 6 illustrates a typical cross correlation over the duration of the squitter. The peak response defines the preamble starting sample. However, by using the preprocessor, only a small number of starting samples around the beginning of the squitter need to be searched. FIG. 7 illustrates a smaller search area.

### Coherent Matched Filter Detector

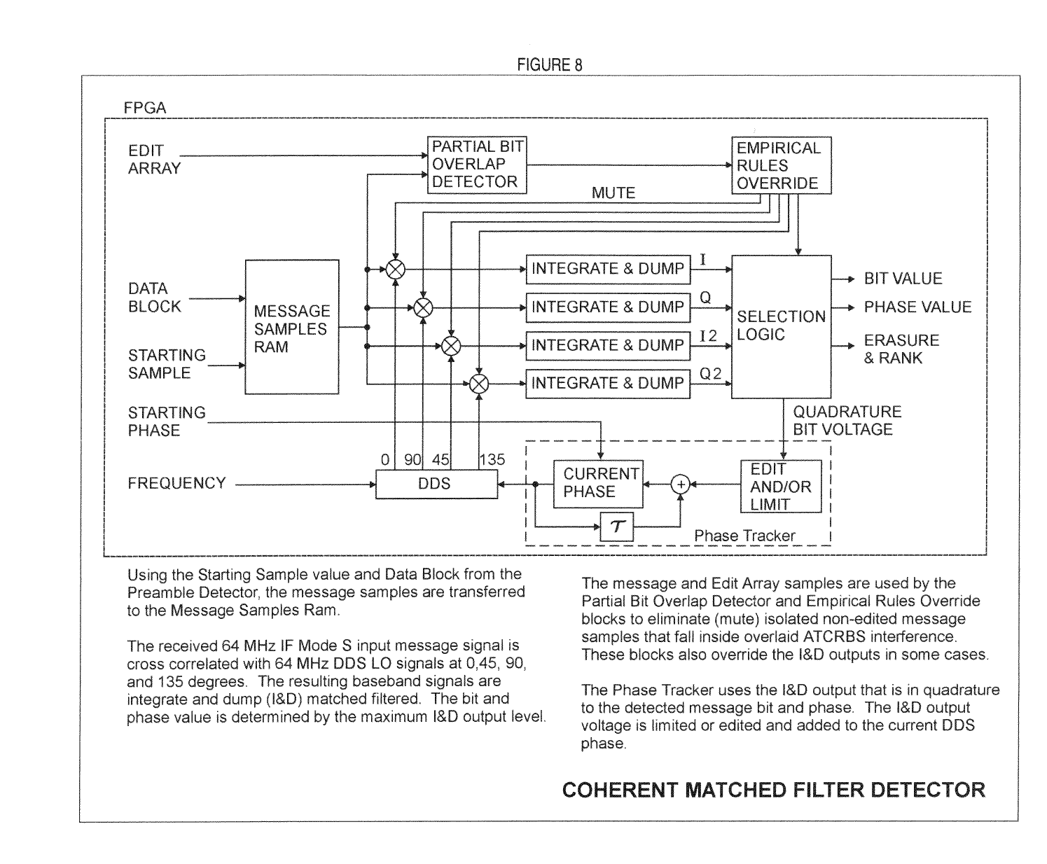

A block diagram of the Coherent Matched Filter Detector for 8PSK is illustrated in FIG. 8. In one embodiment, the Message Samples RAM contains only the squitter samples. The DDS LO creates cross correlation downconversion signals at I&Q (0 and 90 degrees) and at I2&Q2 (45 and 135 degrees). These signals are integrate and dump (I&D) matched filtered over the “1” bit and over the “0” bit durations for each message bit. The value of the message bit and its overlay phase is determined by the maximum I&D matched filter output.

When some of the bit period samples have been edited to remove ATCRBS interference, the Empirical Rules Override block may alter the way the I&D matched filter decodes the bit. The next section, and the following “Bit” sections describe the coherent demodulation process and describe some of the editing rules discovered thus far that can be used to either select the best samples to apply to the coherent matched filter detector, override the default matched filter output, or to marked the decoded bit as low confidence for use by the RS decoder.

### Coherent Demodulation

The data is demodulated by forming a LO signal at an I,Q axis of 0 degrees and an I,Q axis of 45 degrees. That is, each (I,Q) axis pair are rotated 45 degrees from each other.

When the input signal samples are cross-correlated with these 4 LO signals, over the duration of a “1” or “0” message bit duration, either a positive or negative correlated sample value is obtained. These correlated sample values for each LO are integrated over the duration of the “1” and “0” message bit durations.

The maximum integrated value determines which LO axis the input signal is most correlated with and thus indicates the value of the message bit and its phase.

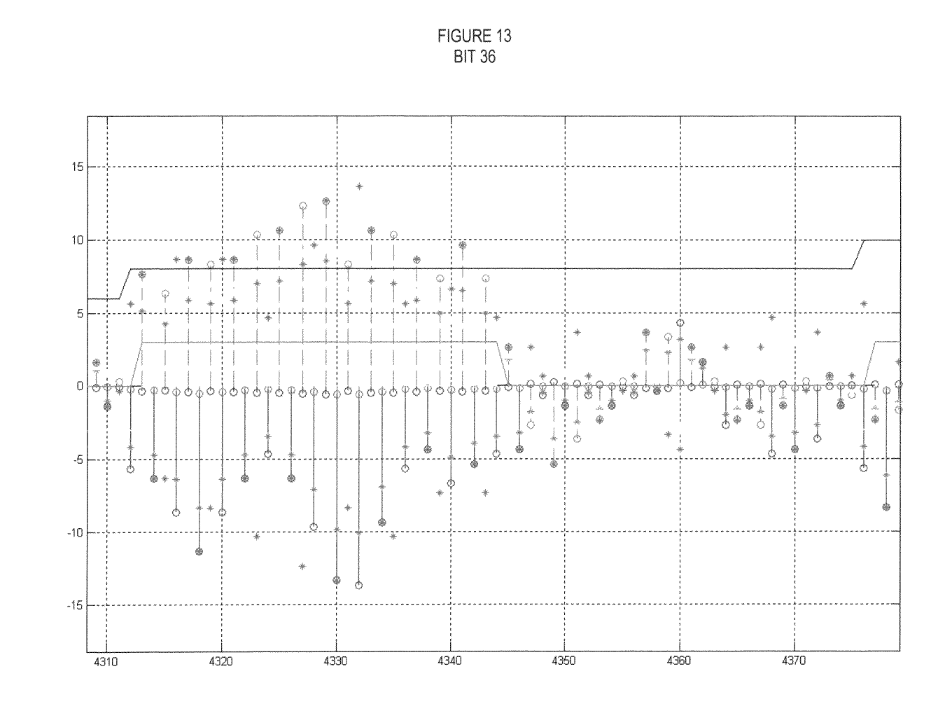

### Bit 36 (FIG. 13)

Bit 36 is a non-interference reference bit to illustrate how to read the sample data. When each input signal sample is multiplied by the I-LO (0 and 180 degree axis) the cross-correlation values are illustrated by the blue stems (shown as solid stems with circle terminals in black-and-white).

The Q-LO (90 and 270 degree axis) cross-correlation values are illustrated by the red stems (shown as dashed stems with circle terminals in black-and-white). The I2-LO (45 and 225 degree axis) cross-correlation values are illustrated by the green (gray) asterisks. The Q2-LO (135 and 315 degree axis) cross-correlation values are illustrated by the yellow asterisks ((shown as light gray crosses in black-and-white).

The pre-edited input signal samples are illustrated by the magenta asterisks when they are not edited and by the red “+” asterisks when they are edited (set to zero). The value of the pre-edited input samples are hard limited to 2 times the edit threshold on these charts to prevent the vertical scale from becoming too large.

The green/(medium gray) solid line illustrates the “1” message bit time duration and the yellow solid/(light gray) line illustrates the “0” message bit time duration.

The value of the black line illustrates the decoded bit and phase value as follows.

| Level | Bit value | Phase (Number) | Phase (Degree) |
|---|---|---|---|
| 2 | 1 | 0 | 0 |
| 4 | 1 | 1 | 45 |
| 6 | 1 | 2 | 90 |
| 8 | 1 | 3 | 135 |
| 10 | 1 | 4 | 180 |
| 12 | 1 | 5 | 225 |
| 14 | 1 | 6 | 270 |
| 16 | 1 | 7 | 315 |
| −2 | 0 | 0 | 0 |
| −4 | 0 | 1 | 45 |
| −6 | 0 | 2 | 90 |
| −8 | 0 | 3 | 135 |
| −10 | 0 | 4 | 180 |
| −12 | 0 | 5 | 225 |
| −14 | 0 | 6 | 270 |
| −16 | 0 | 7 | 315 |

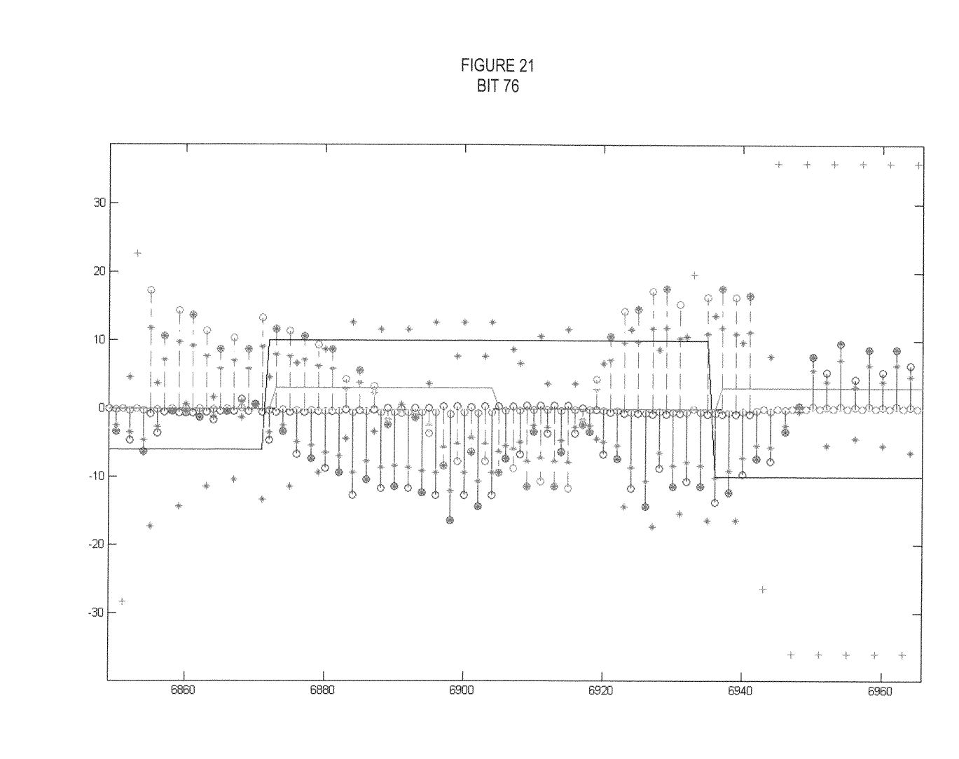

See FIG. 21A for additional illustration.

So, from the black line (value 8), bit 36 was decoded to be a “1” at 135 degrees. This means that maximum correlation was obtained by integrating the Q2-LO correlation samples (yellow asterisks) over the “1,” message bit duration.

This is confirmed in that every yellow/light gray asterisk is positive. In contrast, some of the green (medium gray) asterisks are negative which subtract from the positive green asterisks. Only every other blue and red stems are non-zero so their integrated values are also lower than the integrated yellow asterisks.

Note that the integrated samples over the “0” bit duration will yield a much lower value than over the “1” bit duration. Thus, the message bit is a “1”.

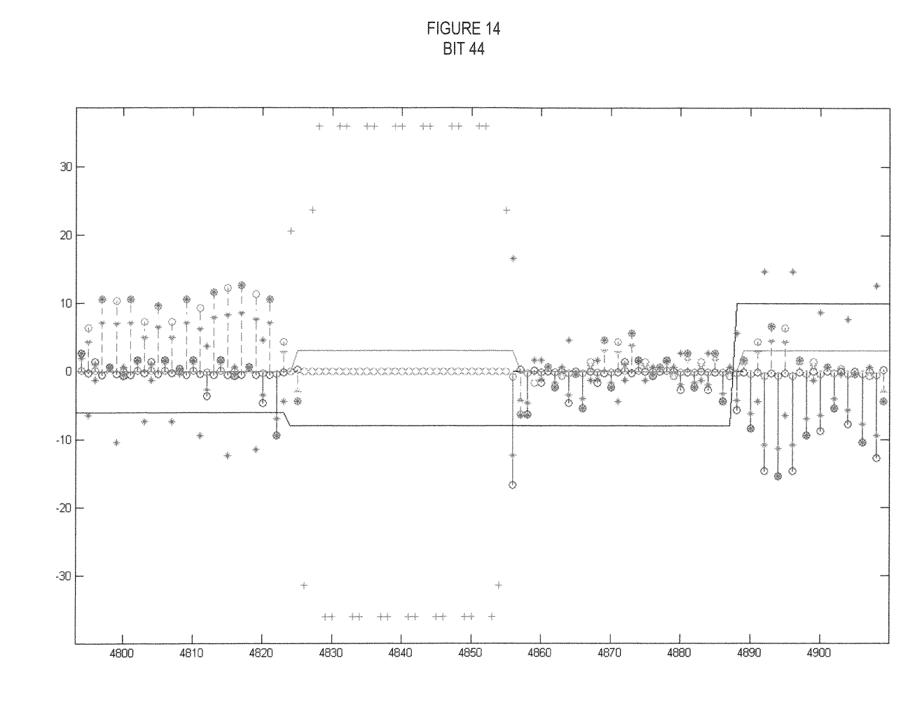

### Bit 44 (FIG. 14)

Note that essentially all the input signal samples were edited out of the “1” bit position. There was more energy in the “0” bit position than was left in the “1” bit position so the message bit was erroneously decoded as a “0”. It is easy to determine that this bit is a “1” by noting that the interference occurred in the bit “1” position and the “0” bit energy is too low to be a valid bit.

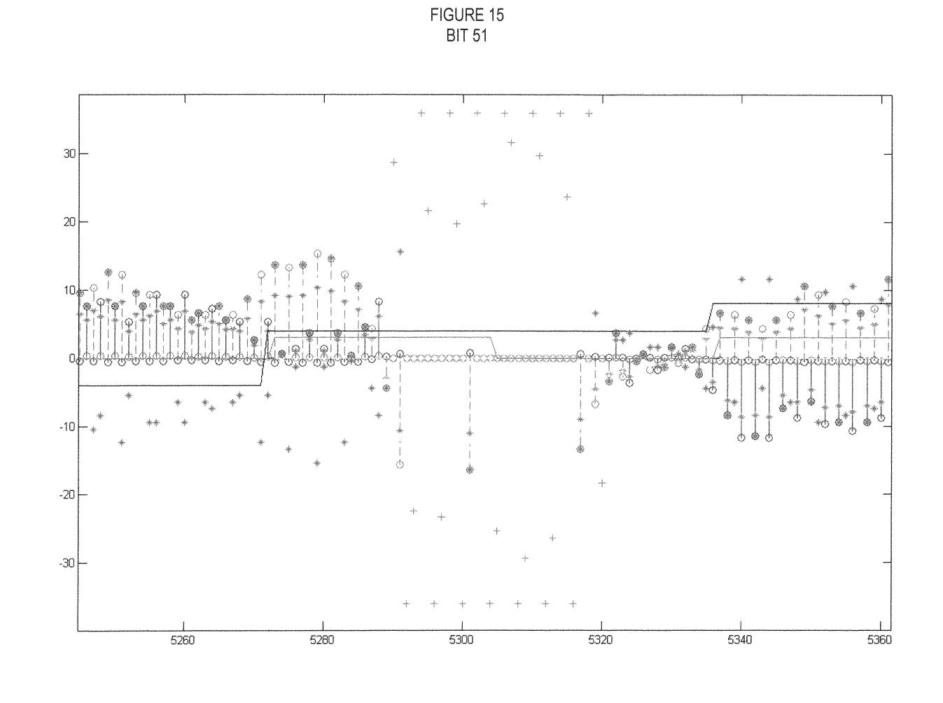

### Bit 51 (FIG. 15)

The phase of bit 51 was decoded as 45 degrees but it should have been 90 degrees. That is, the integral of the green asterisks was greater than the integral of the red stems. However, their integrated values were 62 and 60 respectively so the 45 degrees barely won.

The phase of this bit might be more successfully decoded by only using the samples outside the interference overlap. That is, the stray unedited signal samples might have altered the phase value that could be calculated during the first half of the “1” bit.

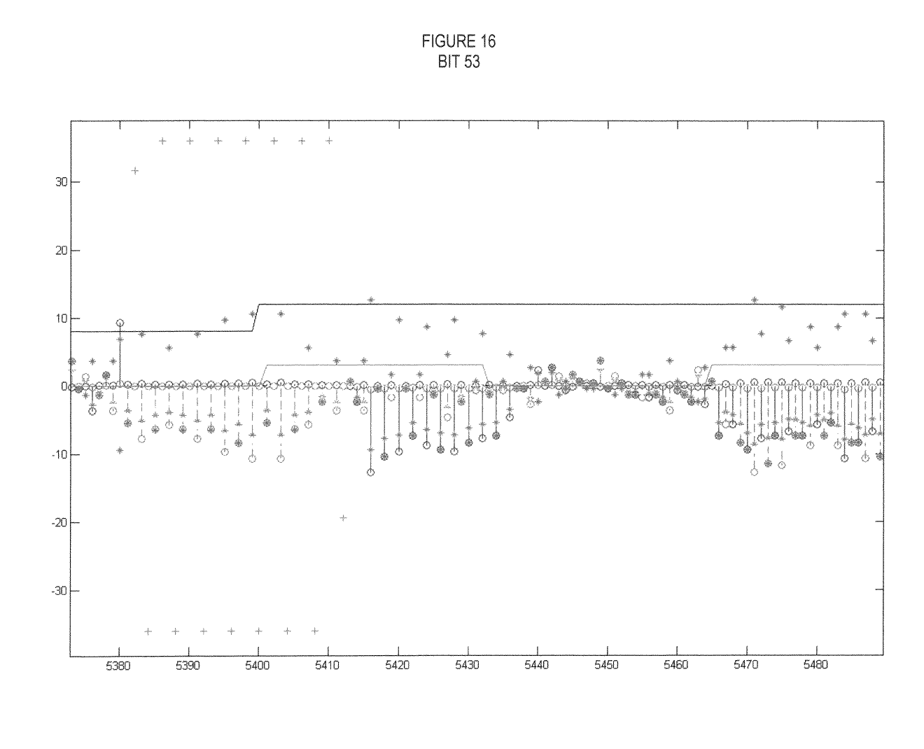

### Bit 53 (FIG. 16)

The phase of bit 53 was decoded as 225 degrees but it should have been 180 degrees. That is, the integral of the green asterisks was greater than the integral of the blue stems. However, their integrated values were −93.0 and −90.7 respectively so the 225 degrees barely won.

Like bit 51, the phase of this bit might be more successfully decoded by only using the samples outside the interference overlap. That is, the stray unedited signal samples might have altered the phase value that could be calculated during the second half of the “1” bit.

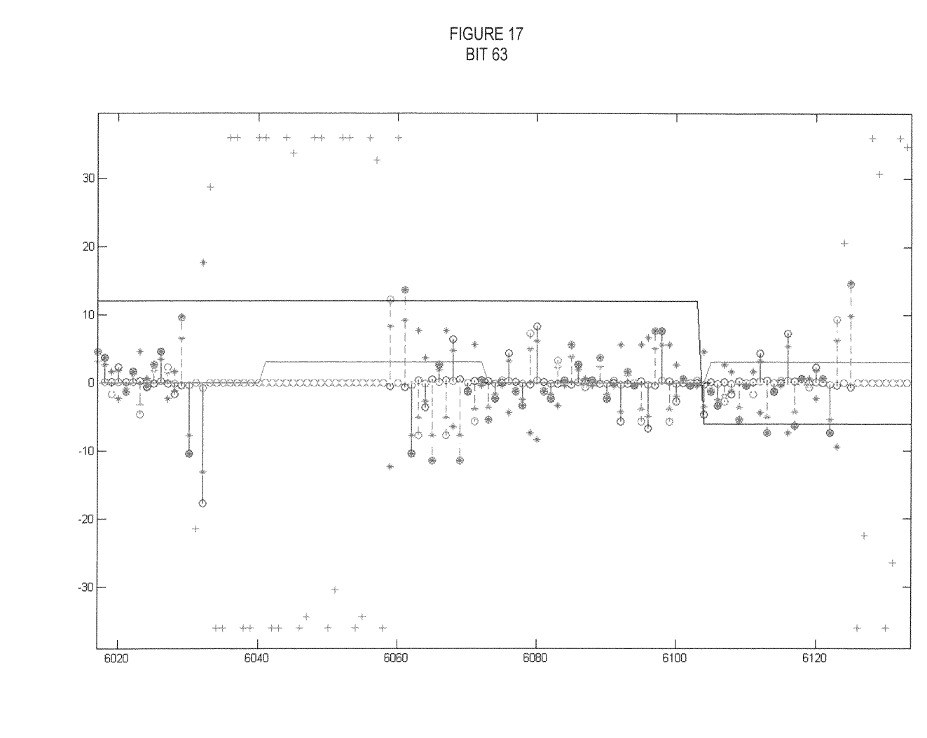

### Bit 63 (FIG. 17)

The phase of bit 63 was decoded as 225 degrees but it should have been 270 degrees. That is, the integral of the green asterisks was greater than the integral of the red stems. However, their integrated values were −17.3 and −17.1 respectively so the 225 degrees barely won.

Like bit 53, the phase of this bit might be more successfully decoded by only using the samples outside the interference overlap. That is, the stray unedited signal samples might have altered the phase value that could be calculated during the second half of the “1” bit.

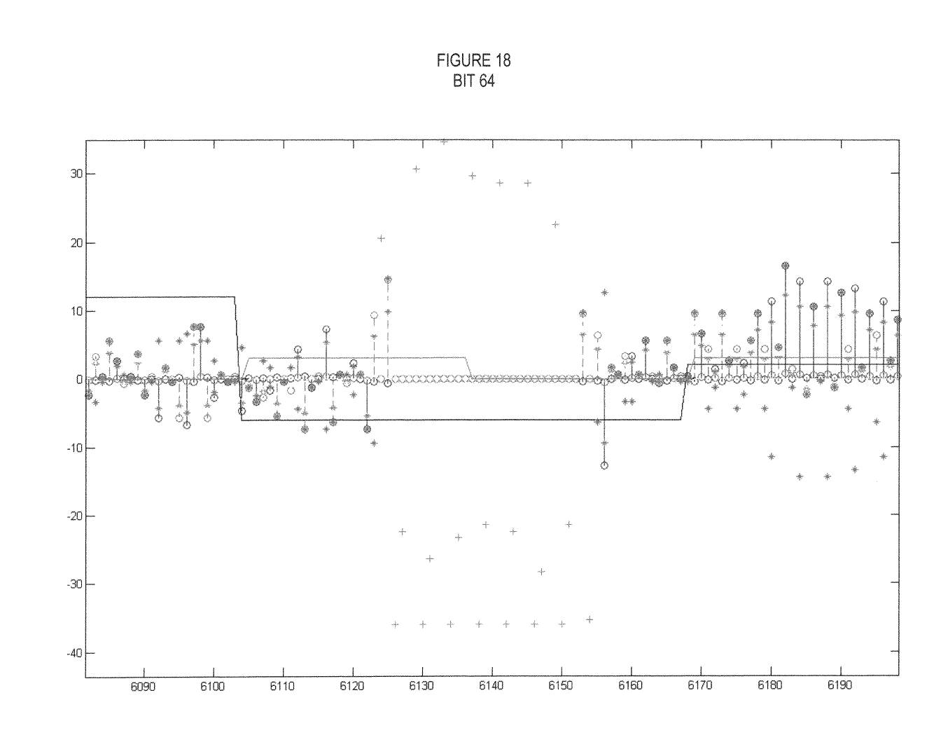

### Bit 64 (FIG. 18)

The phase of bit 64 was decoded as 90 degrees but it should have been 315 degrees. That is, the integral of the red stems was greater than the integral of the yellow asterisks. Their integrated values were 28 and 19 respectively.

This is a strange one in that it appears that the signal level is low in both the “1” and “0” bit positions even outside the interference editing. Perhaps there was some low level ATCRBS that combined with the true signal and noise which altered their sample values. This bit would be marked as low confidence.

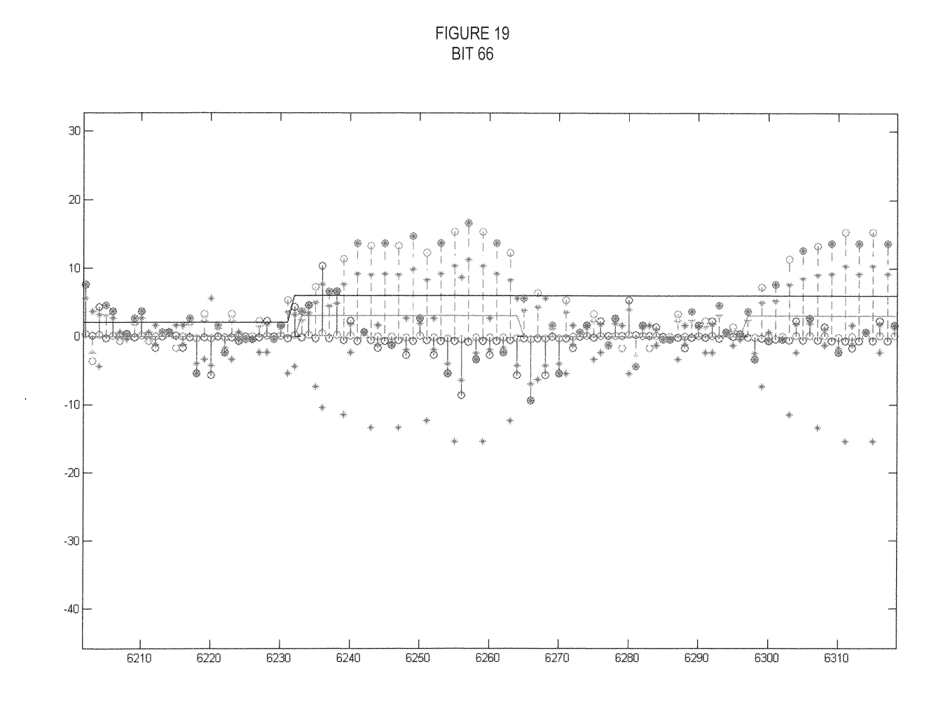

### Bit 66 (FIG. 19)

The phase of bit 66 was decoded as 90 degrees but it should have been 45 degrees. That is, the integral of the red stems was greater than the integral of the green asterisks. Their integrated values were 196 and 151 respectively.

It appears that some low level ATCRBS combined with the true signal and altered its sample values. Note that some of the green asterisks were negative instead of all positive. This reduced the integrated value of the green asterisks. This bit would be marked as low confidence.

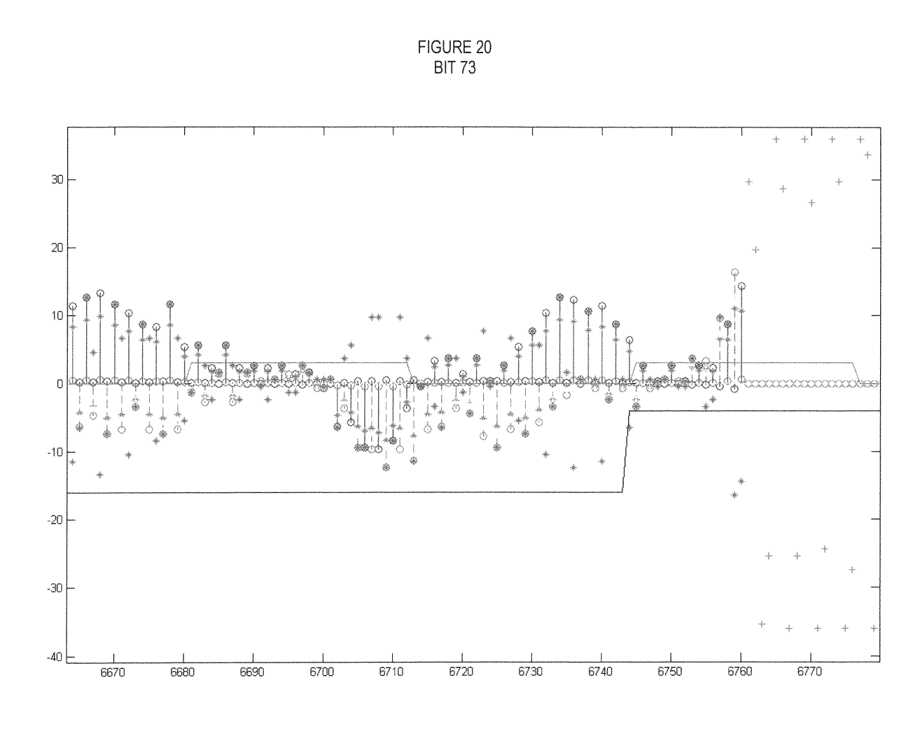

### Bit 73 (FIG. 20)

The phase of bit 73 was decoded as 315 degrees but it should have been 0 degrees. That is, the integral of the yellow asterisks was greater than the integral of the blue stems. Their integrated values were −126 and 84 respectively.

This is a case where low level ATCRBS combined with the true signal and altered its sample values. Note that the signal level is too large for noise in the second half of the “1” bit position and the phase changes between the first and second half of the “0” bit position.

This situation could be used to determine that the ATCRBS overlapped the center of the message bit. Since the samples in the second half of the “0” bit position are greater than the samples in the first half of the “1” bit position, the bit and phase could both be determined from the second half of the “0” bit position.

### Bit 76 (FIG. 21)

The phase of bit 76 was decoded as 180 degrees but it should have been 135 degrees. That is, the integral of the blue stems was greater than the integral of the yellow asterisks. Their integrated values were −168 and 157 respectively.

This is a case where low level ATCRBS combined with the true signal and altered its sample values. Note that the signal level is large for both the noise and signal parts of the message bit. It actually appears that 2 low level ATCRBS interfering pulses overlapped both bits in this message. It would be hard to determine what to do in this situation since there is essentially no noise-only period. Therefore, this bit would be marked as low confidence.

### Erasure Perturbation Generator

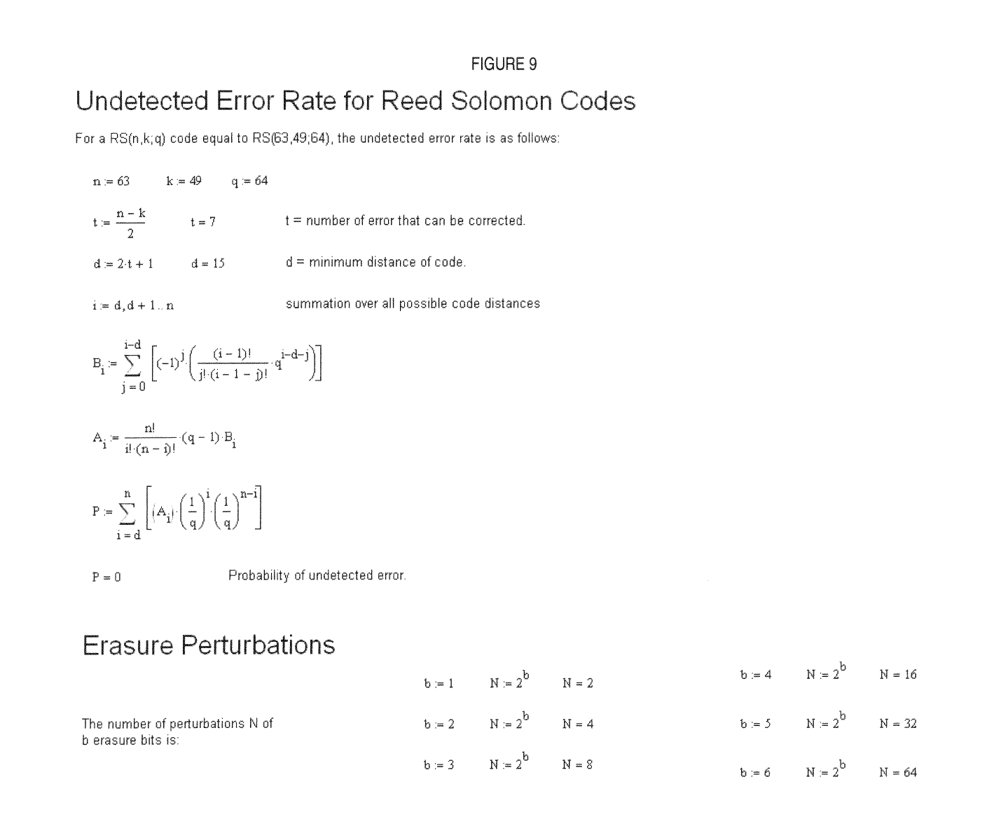

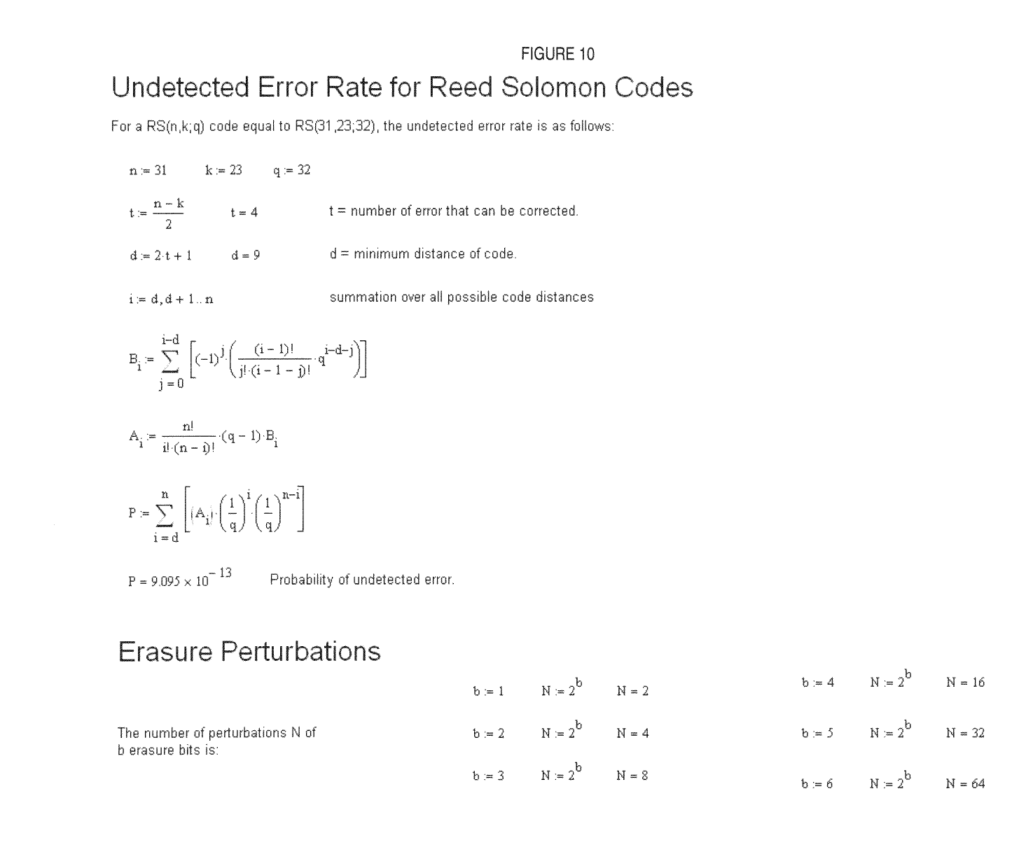

Explanation of the Erasure Perturbation Generator is enhanced by following the illustrations illustrated in FIGS. 9 and 10. In FIG. 9, a RS(63,49;64) code was developed for QPSK overlay FEC coding. This code will correct any 7 errors or will correct a maximum of 14 erasure marked errors.

The probability of an undetected error for this code is essentially 0 and many orders of magnitude than the 10 to the minus 6 value specified by the FAA. Therefore, the low confidence bits of the Mode S message can undergo as many perturbations as we wish without obtaining an erroneous decoding.

If enough FPGA resources are available for 64 decoding trials, we can essentially incur an additional 6 bits of message errors over the RS(63,49;64) decoding capability and still correctly decode the message.

FIG. 10 illustrates a RS(31,23;32) code that was developed to specifically correct Mode S message errors when the overlay bits are used only for error correction and not for additional message data.

### 8PSK Overlay for Mode S Message Correction

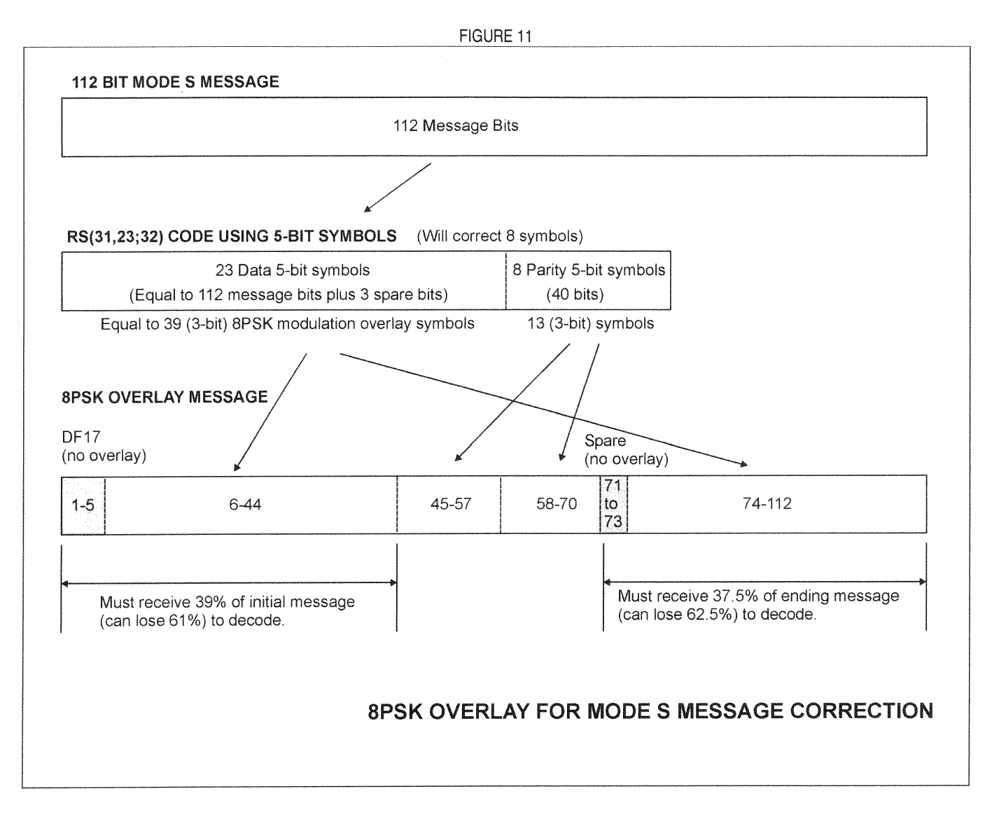

In one embodiment, instead of using overlay bits for additional message data, the overlay bits can also be used to provide additional FEC of Mode S messages. FIG. 11 illustrates a method of adding this enhanced correction capability.

Assume that we add coherent 8-PSK modulation to all Mode S message bits starting with bit 6. That is, DF17 is not phase modulated since it is used for phase lock during the preamble. This leaves 107 message bits available to 8-PSK modulate at 3-bits per symbol. This provides enough bits to create two identical RS(31,23) overlay message codes, each of which repeats the entire 112-bit Mode S message.

One of the messages will be aligned starting with Mode S message bit 6 and the other one aligned to place the end of the overlay code at the end of the Mode S message. This allows a currently received Mode S message to be “stomped on” by another Mode S message or allows a second Mode S message that appears during the reception of a first message to be received. Here are the details.

A RS(31, 23) code is composed of 31 5-bit symbols, 23 of which are data and 8 are parity. We know we can coherently receive 8-PSK overlay at A3 levels in the absence of interference. Therefore, all code errors will be consecutive marked interference errors so this code can correct 8 5-bit symbols.

The first 23 5-bit code data symbols will encode 115 bits (23×5 bits). That is, the 112 bit Mode S message and 3 spare bits can be encoded. The entire RS(31,23) code requires 31 5-bit symbols which rounds out to consume 52 Mode S 3-bit 8-PSK overlay message symbols (31×5 bits=155 bits, 155 bits/3=52 Mode S symbols). Together, both identical RS(31,23) codes consume 104 of the 107 available overlay message symbols.

The 3 spare overlay symbols between the codes will not be modulated to provide phase locking for the second code. If required, both codes can be shorten by one code symbol, with no loss of code performance, to increase the number of un-modulated message symbols.

This code will correct 8 5-bit symbol errors or 13 Mode S overlay message symbols (8×5 bits=40, 40 bits/3=13 Mode S symbols). Therefore, if we receive DF17 and at least the next 39 Mode S overlay message symbols (52−13=39), we can recover the Mode S message. That is, we need to receive at least the first 44 (39+5 DF17) Mode S message symbols out of the 112-bit message.

If the initial portion of the Mode S message encounters the interference, then at least the final 42 (39+3 un-modulated) Mode S symbols must be received. It will be more difficult to obtain phase lock at minimum A3 levels on the remaining symbols since no preamble is available and only a few non-modulated overlay symbols are available. However, phase lock should not be too difficult as the signal level increases. This overlay method will also protect against ATCRBS interference to the extent that no more than 8 code symbols in both codes are lost.

### Null Steering

Null steering is a technique in which the output of two or more antennas are combined to form an antenna array null in the direction of an interfering signal, thus eliminating the interference. For a general overview of the null steering technique, refer to U.S. Pat. No. 4,079,379 (the “'379 patent”), which is described briefly below.

FIG. 1 of the '379 patent illustrates an antenna array pattern in which an antenna lobe is directed towards the desired signal and an antenna null is directed towards the signal to be eliminated. If N is the number of antenna elements in the array, N−1 is the number of independent nulls that can be formed.

FIG. 2 of the '379 patent illustrates a block diagram of the null steering hardware. The signal from each antenna element is split into an in-phase and quadrature-phase component, weighted, and summed with the weighted signal components from the other array elements.

If no signal is injected into the subtract element, the summed feedback signal will drive the weighters such that nulls will be formed in the direction of all incoming signals (assuming the number of independent nulls is equal or greater than the number of signal directions. This occurs because the correlators drive the weighters until the feedback signal is no longer correlated with any component of the input signal.

In a normal CW communication system, a null is prevented from being formed in the direction of the desired signal by forming a replica of the desired signal and using this replica to remove the desired signal from the feedback signal.

FIG. 3 of the '379 patent illustrates a method of creating a replica for a PSK signal by adding a low power quadrature signal to the PSK signal that replicates the PSK signal to be removed. Removing a fixed level of desired signal from the feedback path causes the antenna to form a lobe in the direction of the desired signal. That is, the nulling solution will converge such that the desired signal level out of the summer is equal to the level of the desired signal subtracted. If the summer level falls below the level subtracted, the polarity of the correlators reverse which will drive the weighters in a direction that increases the summer output.

U.S. Pat. No. 4,079,379 illustrates the Least Mean Squares (LMS) algorithm for forming antenna array nulls. The best way of visualizing the LMS algorithm is to think of the nulling solution as a deep bowl in which the current nulling state iteration is a point on the inside surface of the bowl and the final solution (deepest null) is at the bottom of the bowl. With the LMS algorithm, the next nulling state iteration is such that its direction is always directed towards the bottom of the bowl (as opposed to spiraling down to the bottom).

In addition to the LMS algorithm, two other popular algorithms are the Matrix Inversion and Random algorithms. The Matrix Inversion algorithm inverts the covariance matrix formed by the correlators and uses the solution to move from the current point on the nulling solution bowl to the bottom of the bowl in a single iteration. This provides fast convergence at the expense of more complicated computations.

The simplest algorithm is the Random algorithm in which the weighters are arbitrarily adjusted in a direction that increases the null depth. If an adjustment decreases the null depth, the adjustment is removed and an adjustment in a different direction is tried.

### TCAS Null Steering

A TCAS (Traffic alert and Collision Avoidance System) installation includes a top and bottom directional antenna of an aircraft. Each antenna forms 4 beams separated by 90 degrees in azimuth. The half power point between adjacent beams occurs at the 45 degree point. The adjacent beam overlap at 90 degrees is about −12 dB. Therefore, for strong signals, adjacent beams could still be used as null steering array elements for azimuth separations as large as 90 degrees.

The elevation beamwidth is approximately 34 degrees and extends roughly from 20 degrees above the horizon to 15 degrees below the horizon. In level flight and for distances greater than around 5 to 10 miles, both the top and bottom antennas should see most Mode S message sources. For strong signals, the sources should normally also be visible on adjacent beams of either the top or bottom antenna.

So, for most overlapping Mode S messages, it is possible to find at least two separate antenna beams to combine in a null steering array. A two antenna array allows us to form an independent null and thus eliminate a single overlapping source of Mode S interference. Ideally, we would like to find at least 3 separate antenna beams to combine so we can form both an independent null on the undesired signal source and an independent lobe on the desired signal source.

Since antenna elements on the same TCAS antenna are close together, antenna pattern nulls and lobes formed from adjacent elements will be smooth and fairly wide. Conversely, antenna pattern nulls and lobes formed from the top and bottom TCAS antennas will be highly scalloped. That is, due to the wide element separation, multiple nulls will be formed, only N−1 of which will be independent.

### Mode S Message Null Steering Method

In a null steering antenna array, one of the antenna channels can be left non-weighted. This eliminates the trivial nulling solution in which all weights are set to maximum attenuation and all signals are eliminated.

In the Integrated Radio receiver, the antenna with the strongest Mode S signal is normally chosen to be received and processed. So, when forming a TCAS null steering antenna array, select this channel as the non-weighted channel and the next strongest channels as the weighted channels.

Assume that a first Mode S message is being received prior to being overlapped by a second Mode S message. The following steps outline a method by which a 2-channel null steering antenna array null can be formed on either the first or second Mode S message.

1. Record (save) the A/D samples from both antenna receiver channels over the duration of both the first Mode S message and the second overlapping Mode S message.

2. Form a 2-channel null steering antenna array and let it converge on a solution for the non-overlapping portion of the second Mode S message, without using a desired signal estimate. This forms a null on the second Mode S signal.

3. Lock in the null steering solution and playback the recorded data for the duration of the first Mode S message. Since neither the antenna pattern nor the direction of the Mode S signals change over the 120 microsecond message duration, the overlapping second Mode S message signal is eliminated.

4. Repeat steps 2 and 3 letting the null steering converge on a solution for the non-overlapping portion of the first Mode S message, without using a desired signal estimate. This forms a null on the first Mode S signal, eliminates it, and allows the second Mode S message to be decoded.

A 2-channel null steering antenna array can only form a single independent lobe or null. Therefore when a null is formed in step 3, the signal level of the first Mode S message signal will be altered depending on the resulting antenna array pattern. The signal level could increase (lobe formed), decrease (partial null), or remain essentially the same.

Using a 3-channel null steering antenna array, both an independent lobe and an independent null can be formed. It is not possible to transmit a desired signal replica for a Mode S message signal as was done in U.S. Pat. No. 4,079,379. However, the following steps outline a method by which a desired signal identification signal can be produced in a 3-channel null steering antenna array.

1. Record (save) the A/D samples from both antenna receiver channels over the duration of both the first Mode S message and the second overlapping Mode S message.

2. Form a 3-channel null steering antenna array and let it converge on a solution for the non-overlapping interference portion of the first Mode S message using the recorded signal data from channel 1 as a desired signal estimate. This forms an antenna array lobe in the direction of the first Mode S message signal.

3. Next, allow the null steering antenna array to converge on a solution for the non-overlapping interference portion of the second Mode S message, without using a desired signal estimate, and subject to the constraint that it not form a null on the first Mode S signal.

4. Lock in the null steering solution and playback the recorded data for the duration of the first Mode S message. Since neither the antenna pattern nor the direction of the Mode S signals change over the 120 microsecond message duration, the overlapping second Mode S message signal is eliminated while an antenna array lobe is formed in the direction of the first Mode S message.

5. Repeat steps 2 through 4 in which the roles of the first and second Mode S messages are reversed. This forms a null on the first Mode S message and a lobe on the second Mode S message.

In step 3, multiple solutions are available to form a single null on the second Mode S message. The solution selected should be the one that simultaneously maximizes the signal level of the first Mode S message so as to maintain the antenna array lobe on this signal. The following is a general technique for maintaining this lobe.

When a lobe is formed on the first Mode S message, the first Mode S signal vectors received on the 2nd and 3rd antennas are rotated such that the resultant of these 2 summed antenna signals are in-phase with the first Mode S signal on the non-weighted 1st antenna. Therefore, we know that the sum of the 2nd and 3rd antenna weighter values are the amplitude and phase values needed to make this happen.

As the 2nd and 3rd antenna weighter values are adjusted to form the null, our goal is to adjust them in such a fashion that their sum is nearly equal to the sum obtained for the lobe. That is, the lobe is maintained in the current direction while a null is formed in another direction.

### Null Steering Technology

Null steering is a very mature technique in which multiple algorithms have been studied and used for well over 30 years. Many of the algorithms that were not practical to use in the past may now be practical due to advances in FPGA hardware. So, implementing a TCAS null steering solution should not be an issue.

A side benefit of the null steering technique is that by replacing the integrators following the correlators with filters, the structure becomes a pre-detection combiner which will optimally combine a desired signal from each antenna. This technique could provide a 3 dB SNR improvement on long range weak signals by combining the same azimuth beams of the top and bottom antenna.

### GPS Stabilized Frequency

Over time, an ever-increasing proporation of aircraft will become GPS (Global Positioning System)-equipped. Therefore, timing data from onboard GPS receivers can be used to stabilize the Mode S transmit and receive frequency so that only a single frequency needs to be searched for preamble and starting phase in the Preamble, Frequency, and Initial Phase Detector block.

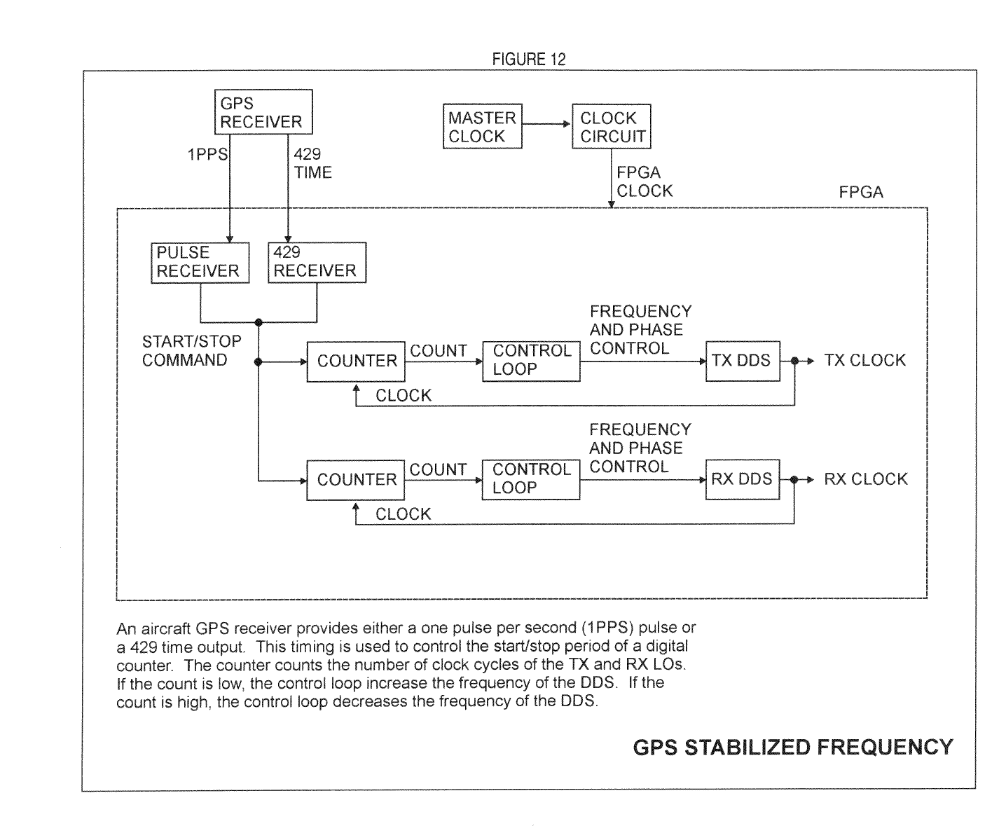

A block diagram of the GPS Stabilized Frequency concept is illustrated in FIG. 12. Both the transmit signal synthesis and receive IF baseband signal are controlled by a DDS in the FPGA. Each cycle of these clocks can be counted over the duration of the GPS timing marks to determine if they are on frequency. If the count is low, the Control Loop will increase the frequency of the DDS and decrease the frequency if the count is high.

If a one pulse per second (1PPS) pulse is available, the counting period will be one second. If only 429 timing words are available, then a counting period of multiple minutes or seconds will be required to obtain the desired frequency resolution.

Typically, the short term stability of the master clock to the FPGA is very stable. Therefore, long timing periods can be used. Master clocks typically drift slowly with age and more quickly with temperature. If temperature information is available, the control loop can use it to predict the correct control input to the DDS prior to completing a long initial count to speed up a power-on frequency setting.

The Mode S Demodulation Process block diagram provides the optimum performance structure for implementation in a FPGA, which in many embodiments may be a preferred approach. The Binary Detector application outside of the radar field is a novel implementation that provides for enhanced functionality of embodiments of the present invention.

The combination of a Coherent Matched Filter Detector with an Empirical Rules Override offers improved performance because the use of these two elements provides a seamless merging of optimum sensitivity and maximum interference immunity. The coherent matched filter provides maximum sensitivity when no interference is present and the rules override compensates when ATCRBS interference is present. The Erasure Perturbation Generator provides for a higher percentage of successfully received Mode S messages. In any communications system, obtaining a low missed-message metric is highly desirable.

Embodiments applying Null steering to TCAS antennas also provide substantial benefits. This technique provides us with a fundamentally different approach to reduce interference. Null steering can be used in combination with the other interference techniques described above to further enhance the probability of message reception. The structure of a pre-detection combiner is very similar to that of null steering. A pre-detection combiner can be used to further increase the reception sensitivity in non-interference environments.

FIG. 22 illustrates a block diagram that shows an IRF receiver with an additional ATC overlay demodulator shown in the dashed area. Various embodiments include In-phase and Quadrature-phase (I and Q) mixers which convert the 80 MHz IF signal which is digitized by the A/D converter (aliased down to 16 MHz by the 64 MHz sample rate) to a base-band signal. The output of the I and Q mixers go through decimating Low Pass Filters (LPF), which have a 16 MSPS output rate, and remove the frequency components not at base-band. The I and Q LPF outputs then go through an amplitude detector, which squares and sums the I and Q signals and then detects the signal through a logarithmic detector. The output of the detector is a linear in dB representation of the IF signal amplitude. The output of the detector goes through a preamble detector and then a data detector, similar to the design in DO-260A Appendix I for the multi-sample technique. The MOPS design forms a reference RF level based on the 4 preamble pulses. The data demodulation block forms both data value and confidence values for each bit (56 or 112). The data confidence is formed based on the RF reference level from the preamble detector. If pulses are outside a window based on the reference level, then the bit is declared as low confidence. The processor uses error detection and correction techniques on the data based on the low confidence values, and attempts to correct incorrect bit decisions. The output is sent to the micro-processor for processing.

The ATC Overlay Demodulator blocks are shown in the dashed area. The output of the I and Q LPF go to a phase detector function which outputs an angular value for each sample, which is the arc-tangent of the I and Q LPF output signals. If there was no frequency offset in the system, then the I and Q LPF outputs would be a DC signal during a pulse (which has no phase change), otherwise it will have an AC component whose frequency is a combination of the TX frequency offset (from 1090 MHz) and the RX frequency offset (from 1090 MHz). Note the RX frequency offset would be no more than 10 KHz because of the TCAS accuracy spec. The TX frequency could be offset by as much as 1 MHz (given the current DO-181 specification), which could generate a significant AC frequency component (of 1 MHz). If the Mode S TX frequency was constrained to 10 KHz, no frequency compensation would be required, however this would drive up the cost of the transponder design. The demodulator design removes the frequency offset from the demodulation process in order to provide proper decoding. The demodulator design also uses the low confidence bit criteria to eliminate errors in the phase demodulation process.

In order to detect the frequency offset, it is necessary to have a sample of the received signal that has a with a constant or known data pattern. The sample time must be sufficient to determine the offset in the presence of noise and interference. If the data pattern is unknown, it may not be possible to extract the frequency offset. One aspect of an embodiment of the present invention is the use of a non ADS-B message from a Mode S Transponder which has a constant phase pattern. Mode S Transponders transmit DF-11 Squitters (56 bits) at a rate of once per second, and up to 5.2 DF-17 ADS-B Squitters (112 bits per squitter) per second. The Mode S Transponder would be required to transmit a DF-11 with no phase modulation, the DF-17 ADS-B squitters would have phase modulated data bits. The demodulator would then determine the frequency offset when a DF-11 squitter is received using up to 60 Mode S Pulses for the determination (4 preamble+56 data pulses). The frequency offset would be stored in a look-up table, along with the Mode S Address of the transponder. When a DF-17 Squitter is received, the demodulator would “look up” the frequency offset from the table based on the Mode S Address, and use this to remove the offset from the demodulation process.

The Mode S waveform has 56 or 112 data pulses which use pulse position modulation, so therefore the position of the pulse changes within a data chip (1 micro-second) based on the data value (1 or 0). During the “no energy” time, no useable data is output from the Phase Detector. Another issue with the Mode S waveform is that it can have overlapping interference pulses from ATCRBS transponders. This may be at the same level as the Mode S waveform or may overlay it at a higher level. When this occurs the desired phase information may be corrupted for these over-layed pulses.

In order to determine the frequency offset for the incoming Mode S signal, the output of the I/Q Phase Detector block would go to a FIFO so it is delayed until after the Mode S amplitude data is processed by the Mode S Reply Processor Block. The output of this block has the bit values for each bit and also the confidence level for each bit.

The output of the 1st FIFO along with the 112 bit value and bit confidence field would go to the Frequency Offset Estimate block shown in FIG. 23. This block would take the angular difference between successive samples which are output from the FIFO in order to determine if the angle is changing. The input to the LPF would be switched between 3 positions based on timing information and data from the Mode S Reply Processor. Prior to the start of the squitter processing, the LPF would be set to 0 (no offset). Based on the 112 bit value data, the switch would be connected to the output of the sum block only when a pulse is present. If the data bit was a 1, then it would only be connected during the first half of the bit time when energy is present. Note that this would only be switched to this position during the middle portion of the pulse, and would not be switched in during the pulse rise & fall time or during a phase transition for a 1 micro-second pulse (0 followed by a 1).

The switch would be placed in the top position (hold value) at all other times as follows: (1) When no energy is in the bit position; (2) During the rise/fall time of the pulse; and/or (3) Whenever a low confidence bit is detected. Since the data cannot be trusted during a low confidence bit, it would not be input to the LPF during that portion of the waveform.

The output of the 1st FIFO would also be connected to the 2nd FIFO. This allows the data to be delayed until the Frequency Offset Estimate is completed. After all 112 bits from the output of the 1st FIFO are processed by the Frequency Offset Estimate Block, the differential phase detector block would process the angular data along with the predicted frequency offset.

The differential phase detector block also uses the 112 bit value data to determine where to take the frequency sample for each bit, which typically is in the middle of the bit. The phase detector would take the angular data for the current bit minus the angular data from the previous bit, and compensate the measurement with the frequency offset error. If the “current” bit is also marked as low confidence by the Mode S Reply Processor, then the output of the Phase Detector would mark this bit along with the following bit as “Phase” low confidence. Therefore for every 1 amplitude low confidence bit, 2 phase low confidence bits will be generated.

The DSP card which contains the high speed D/A converters would generate the required waveforms for TCAS interrogations and Mode S replies. The intent is to use digital techniques for controlling transmitter spectrum. The DSP FPGA can use a 14 bit A/D converter for digitizing the feedback power output. An Analog Devices DAC board can be added which can be used for controlling the gate modulation voltages on the LDMOS devices. Using the feedback from the A/D converter, a compensation algorithm coded in the FPGA can provide the necessary modulation voltages to generate the Whisper/Shout steps.

Those of skill in the art appreciate that an optional interface from the DSP FPGA to a PC could be added if required for additional functionality.

The block diagrams disclosed herein are shown primarily to illustrate the computational flow of the overall implementation. In various embodiments using actual FPGA code, a single data RAM could be used and address pointers passed to the various modules that use the data. That is, a single RAM could be used to store and retrieve incoming A/D samples. The particular implementations shown and described above are illustrative of the invention and its best mode and are not intended to otherwise limit the scope of the present invention in any way. Indeed, for the sake of brevity, conventional data storage, data transmission, and other functional aspects of the systems may not be described in detail. Methods illustrated in the various figures may include more, fewer, or other steps. Additionally, steps may be performed in any suitable order without departing from the scope of the invention. Furthermore, the connecting lines shown in the various figures are intended to represent exemplary functional relationships and/or physical couplings between the various elements. Many alternative or additional functional relationships or physical connections may be present in a practical system.

Changes and modifications may be made to the disclosed embodiments without departing from the scope of the present invention. These and other changes or modifications are intended to be included within the scope of the present invention, as expressed in the following claims.

What is claimed is:

1. A method comprising: demodulating a multiply-modulated signal.
